(19) United States
(12) Patent Application Publication
(10) Pub. No.: US 2005/0068768 A1
(43) Pub. Date: Mar. 31, 2005

(54) Illuminating pocket

(76) Inventor: Wei-Jong Chiu, Tainan City (TW)

Correspondence Address: Wei-Jong Chiu, P.O. Box 90, Tainan City, 704, TW

(21) Appl. No.: 10/671,577

(22) Filed: Sep. 29, 2003

(51) Int. Cl. F21L 4/04

(52) U.S. Cl. 362/203

(57) ABSTRACT

An illuminating pocket comprises a pocket; an inner bag being on a back side of the pocket; an illuminating device being installed in the inner bag at the back side of the pocket; the illuminating lamp being connected to the plate body and protruding upwards to be out of the inner bag; the battery seat being protruded with a switch; the switch protruding out of the notch of the inner bag; one end of the battery seat having a battery cover which protrudes out of the opening of the inner bag so that battery can be updated easily. By turning ON the switch, the illuminating lamp will light up. The combination of the inner bag and pocket is by one of using sticky blankets adhered on the inner bag and pocket, using buckles, or using zipper.

### BACKGROUND OF THE INVENTION

1. Field of the Invention

The present invention relates to pockets, and particular to an illuminating pocket with an illuminating device. The illuminating pocket is portable easily and has a function of lighting up.

2. Description of the Prior Art

The general pocket has a bag. Two sides of the bag are installed with buckles and belts. By buckling the buckles, the bag can be suspended from the waist. However, this prior art design is only used to place some objects, while if it is desired to take something from the pocket in dark, the user must take a flashlight by one hand. Thus only one hand can pick object up from the pocket. If the object is heavy, it becomes very difficult and inconvenient, or the operation must be performed many times.

### SUMMARY OF THE INVENTION

Accordingly, the primary object of the present invention is to provide an illuminating pocket which can be carried easily and convenient, even in dark the user can take objects from the illuminating pocket easily.

To achieve above object, the present invention provides a illuminating pocket which comprises a pocket; an inner bag being on a back side of the pocket; an illuminating device being installed in the inner bag at the back side of the pocket; the illuminating lamp being connected to the plate body and protrudes upwards out of the inner bag; the battery seat being protruded with a switch; the switch protrudes out of the notch of the inner bag; one end of the battery seat having a battery cover which protrudes out of the opening of the inner bag so that battery can be updated easily. By turning ON the switch, the illuminating lamp will light up. The combination of the inner bag to pocket is by one of using sticky blankets adhered on the inner bag and pocket, using buckles, or using zipper.

The various objects and advantages of the present invention will be more readily understood from the following detailed description when read in conjunction with the appended drawing.

### BRIEF DESCRIPTION OF DRAWINGS

FIG. 1 is an exploded perspective view of the present invention.

FIG. 2 is an assembled perspective view of the present invention.

FIG. 3 shows one application of the present invention.

### DETAILED DESCRIPTION OF THE PREFERRED EMBODIMENTS

The use and embodiments of the present invention will be described herein with the preferred embodiments with the drawings.

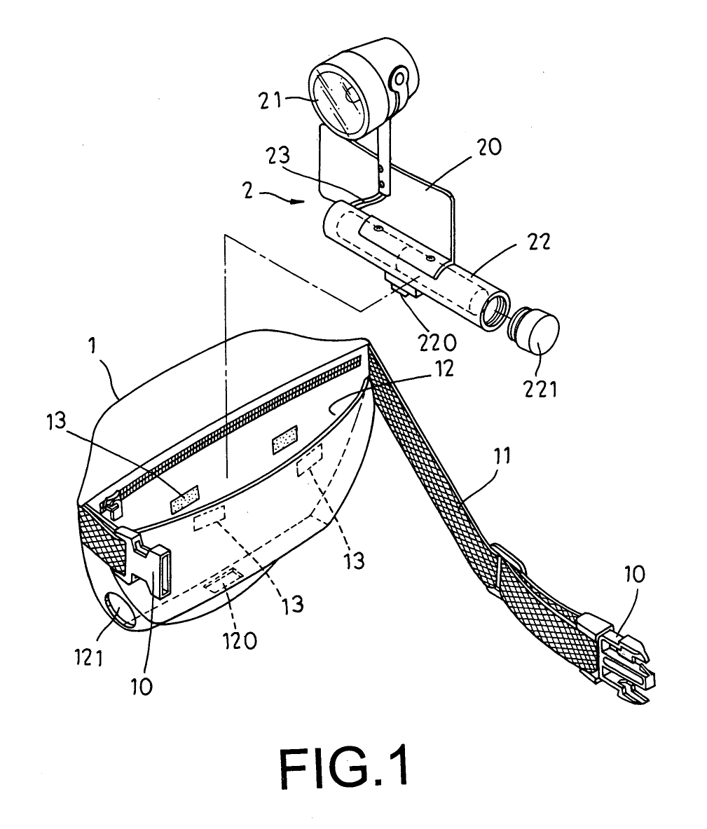

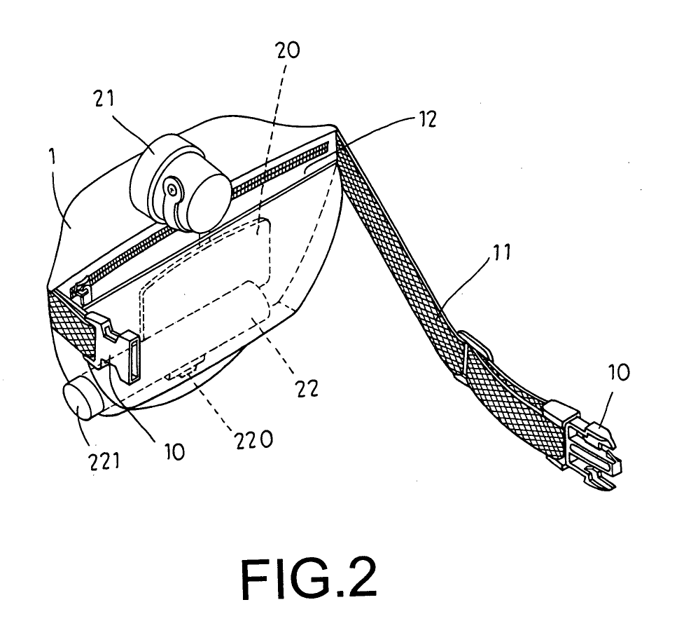

Referring to FIGS. 1 and 2, the present invention comprises the following elements.

A pocket 1 has belts 11 at two sides thereof. Each belt 11 has a buckle 10. A backside of the pocket 1 is installed with an inner bag 12. A predetermined position of the inner bag 12 has a notch 120. A lateral side of the pocket 1 has an opening 121. An inner surface of the inner bag 12 and a back surface of the pocket 1 have respective sticky blankets 13 so that the inner bag 12 can be stuck to the pocket 1.

An illuminating device 2 is installed in the inner bag 12 at the backside of the pocket 1. The illuminating device 2 has a plate body 20, an illuminating lamp 21, a battery seat 22, etc. The plate body 20 has a cambered shape so as to match the requirement of ergonomics so that the user can carry the present invention comfortably. The illuminating lamp 21 is connected to the plate body 20 and protrudes upwardly to be out of the inner bag 12. The battery seat 22 is protruded with a switch 220. The switch 220 protrudes out of the notch 120 of the inner bag 12. One end of the battery seat 22 has a battery cover 221 which protrudes out of the opening 121 of the inner bag 12 so that battery can be updated easily.

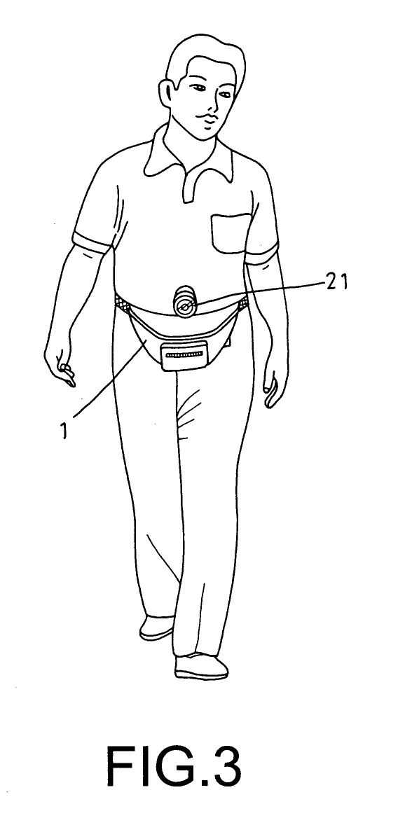

In assembly, referring to FIGS. 2 and 3, the illuminating device 2 is placed in the inner bag 12 of the pocket 1 so that the illuminating lamp 21 protruded out and upwards. The battery seat 22 is placed at the bottom of the inner bag 12. The switch 220 protrudes upwards and outwards. The battery seat 22 is at a bottom of the inner bag 12. The switch 220 protrudes from the notch 120 of the inner bag 12 of the pocket 1 and the battery cover 221 protrudes out of the opening 121 of the inner bag 12 so that the battery can be updated easily. Finally, the inner bag 12 and pocket 1 are stuck by the sticky blankets 13 of the inner bag 12 and the pocket 1. Thereby, by pushing the switch 220 to an ON position, the illuminating lamp 21 will illuminate.

Advantages of the present invention will be described herein.

The illuminating device 2 of the present invention is installed with a cambered plate body which is matched to the requirement of ergonomics so that the user can carry it comfortable.

The inner bag is stuck to the backside of the pocket by the sticky blankets, or the inner bag is seamed to the pocket, or is buckled to the pocket by buckles.

The illuminating device is adhered to the pocket so as to provide light to the user without use flashlights. It is only necessary to push on the switch to provide light to users.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

1. An illuminating pocket comprising:
a pocket;
an inner bag being on a back side of the pocket; a predetermined position of the inner bag having a notch; a lateral side of the pocket having an opening;
an illuminating device being installed in the inner bag at the back side of the pocket; the illuminating lamp being connected to the plate body and protruding upwards to be out of the inner bag; the battery seat being protruded with a switch; the switch protruding out of the notch of the inner bag; one end of the battery seat having a battery cover which protrudes out of the opening of the inner bag so that battery can be updated easily;
wherein by turning ON the switch, the illuminating lamp will light up.

2. The illuminating pocket as claimed in claim 1, wherein the combination of the inner bag to pocket is by one of using sticky blankets adhered on the inner bag and pocket, using buckles, and using zipper.
